(19) United States
(12) Patent Application Publication
(10) Pub. No.: US 2002/0091561 A1
(43) Pub. Date: Jul. 11, 2002

(54) Method for collecting and distributing consumer advice to select consumers

(76) Inventor: Barbara Rae Ryan, New York, NY (US)

Correspondence Address: Philmore H. Colburn II, Cantor Colburn LLP, 55 Griffin Road South, Bloomfield, CT, 06002, US

(21) Appl. No.: 09/756,374

(22) Filed: Jan. 8, 2001

(51) Int. Cl. G06F 17/60

(52) U.S. Cl. 705/10; 705/14

(57) ABSTRACT

A method for collecting and distributing consumer advice to a group of consumers is disclosed. The method includes soliciting consumer advice from the group of consumers and collecting solicited advice submitted by the group of consumers. Individual submissions of the solicited advice are then published to the group of consumers.

### BACKGROUND OF THE INVENTION

This invention relates generally to consumer services and, more particularly, to a method for collecting and distributing consumer advice to selected consumers.

Competition to attract consumers in the retail industry is substantial, as consumers have ever increasing choices with regard to the variety of goods and services available. More and more retailers are offering discounts and promotions in order to attract business. In addition, attempts at increasing sales and customer loyalty are also made by offering some type of reward system. For example, the airline industry rewards loyal customers using frequent flyer programs. Further, attempts have also been made to develop “frequent shopper” marketing and sales promotion services in retail sales. Some retail grocery chains, for example, provide coupons based upon consumer purchase amounts accumulated during a particular shopping transaction.

Although certain “value” programs offered to consumers may increase sales and attract business, these programs are typically conceived and generated by the business entity seeking to increase their sales. A need, therefore, exists for a “value” added program responsive to the ideas and needs of the consumers themselves.

### BRIEF SUMMARY OF THE INVENTION

The above discussed and other drawbacks and deficiencies of the prior art are overcome or alleviated by a method for collecting and distributing consumer advice to a group of consumers. The method includes soliciting consumer advice from the group of consumers and collecting solicited advice submitted by the group of consumers. Individual submissions of the solicited advice are then published to the group of consumers. In a preferred embodiment, the selected individual submissions are published to a subset of the group of consumers.

In an alternative embodiment, the promotional value of the solicited advice is evaluated to determine whether the advice shall be published in combination with a promotional offer. If so, a promotional offer is generated, with the promotional offer having a subject matter related to the advice.

### BRIEF DESCRIPTION OF THE DRAWINGS

Referring to the exemplary drawings wherein like elements are numbered alike in the several Figures:

FIG. 1 is a flow diagram illustrating a method for soliciting and distributing consumer advice in accordance with an embodiment of the invention;

FIG. 2 illustrates one page of an exemplary form used in soliciting consumer advice, according to an embodiment of the invention;

FIG. 3 illustrates another page of the exemplary form shown in FIG. 2;

FIG. 4 illustrates an example of a promotional offer generated in accordance with an embodiment of the method; and

FIG. 5 illustrates another example of a promotional offer generated in accordance with an embodiment of the method.

### DETAILED DESCRIPTION OF THE INVENTION

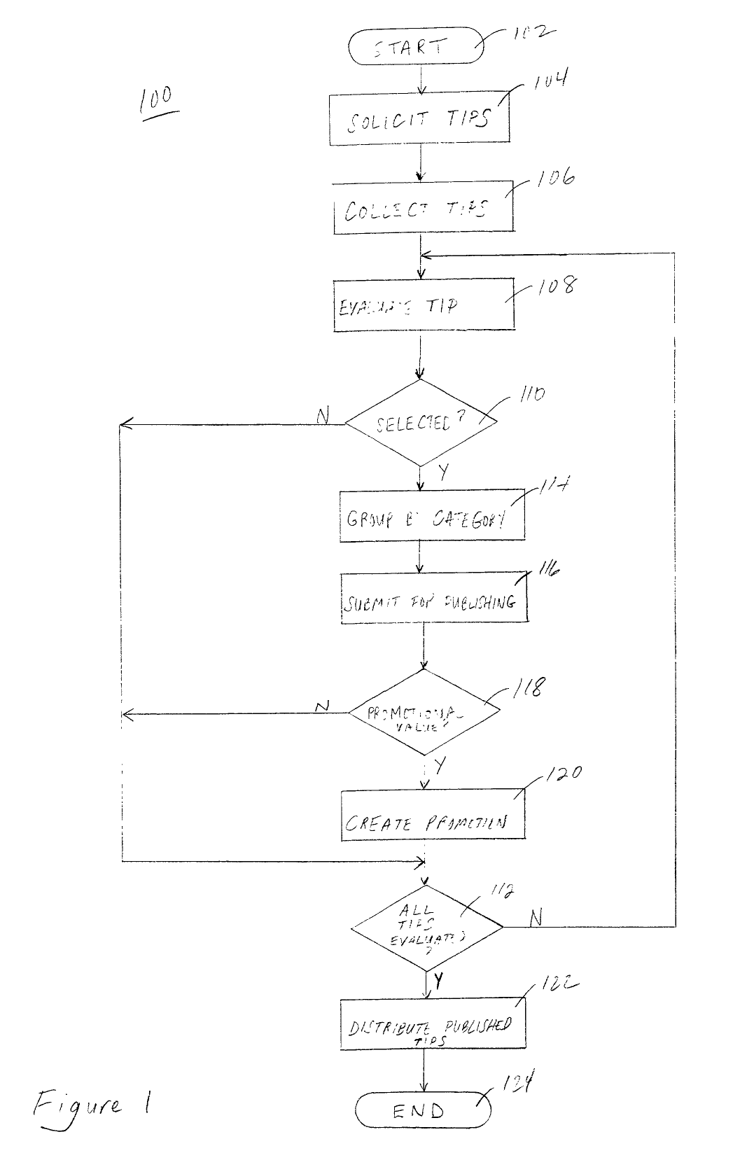

Referring initially to FIG. 1, a method 100 for soliciting and distributing consumer advice to a selected group of consumers is shown. Method 100 begins at start block 102 and proceeds with a solicitation at block 104 of consumer advice (hereinafter referred to as “tips”) from members of a selected group. In a preferred embodiment, method 100 is executed within the framework of a consumer credit account program wherein the selected group of consumers are those individuals belonging to the credit account program. However, one skilled in the art will appreciate that method 100 may be implemented with other consumer programs or as a stand-alone program. Thus, in the present embodiment, advice is then solicited at block 104 from members of the credit account. Several possible embodiments of solicitations are contemplated, such as questionnaires included on account application forms (described hereinafter) or on account billing statements.

Method 100 then proceeds to collect submitted tips at block 106, where they are individually evaluated for purposes of publication at block 108. If at decision block 110 a tip is not selected for publication, method 100 skips to decision block 112, which is described hereinafter. Those individual tips that are selected for publication at decision block 110 are grouped according to a defined category at block 114 and submitted for publication at block 116 for eventual distribution to some or all individuals belonging to the credit account program. Next, method 100 then further evaluates the promotional value of the collected tip at decision block 118. If the tip is determined to have promotional value, it is selected for use in combination with a promotional offer or purchase, and method 100 proceeds to block 120 where the promotion or offer is created. Finally, method 100 also keeps track of the individual consumers providing the tips (whether used in publication or not) for targeting of specific offers thereto. At this point, method 100 proceeds to decision block 112 to determine whether all submitted tips have been evaluated. If not, method 100 returns to block 108 and the above process is repeated until all submitted tips are evaluated. Once this has occurred, all published tips are distributed at block 122 to certain selected consumers and method comes to an end at block 124.

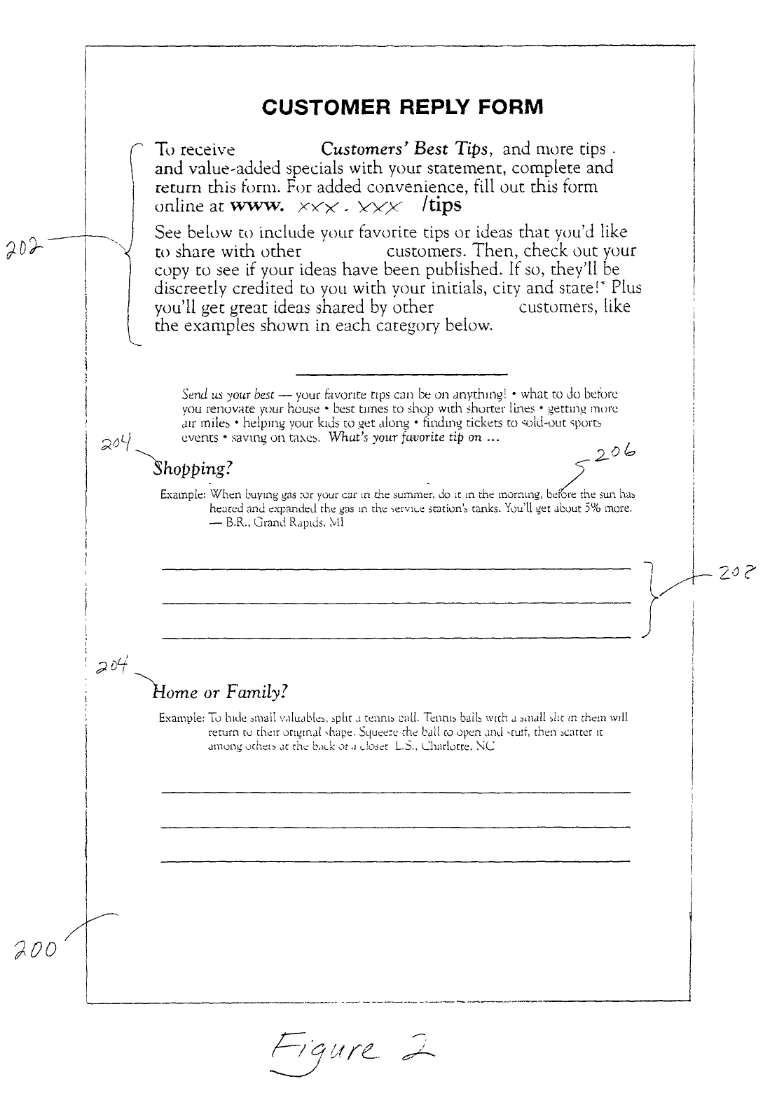

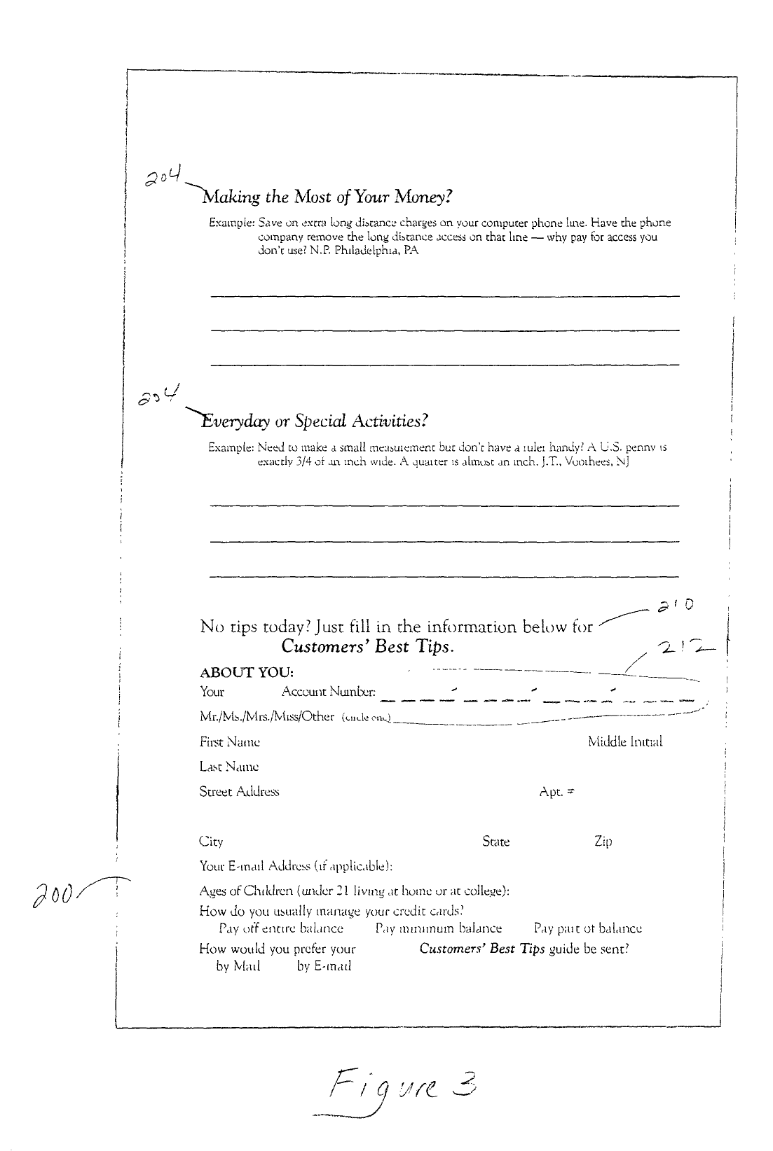

FIGS. 2 and 3 illustrate one possible embodiment of the solicitation of method 100, as represented by block 104 in FIG. 1. A form 200 includes an explanation paragraph 202 (shown in FIG. 2) that describes the program to a potential consumer. Paragraph 202 indicates that the requested consumer tips may be submitted by filling out form 200. In addition, a series of tip categories 204 are listed on form 200, along with an accompanying example thereto. The various tip categories 204 listed in form 200 include, but are not limited to “shopping”, “home and family”, “money”, “everyday or special activities”. Certain selected tips submitted by a consumer may be used as an example in form 200. For instance, an exemplary tip 206 listed under the “shopping” category 204 proffers advice regarding filling an automobile gas tank during the morning hours of the summer season. An empty space 208 is provided thereunder for a consumer to write any tips or advice falling under the general category indicated.

A potential consumer need not supply any tips or advice in any of the listed categories. However, in the illustrated embodiment shown in FIG. 3, the potential consumer is asked at 210 to fill out information such as name, address and the like. In a preferred embodiment, method 100 is implemented in combination with a credit card account. Once the consumer submits the application form 200 with the credit account information 212, he or she is eligible to receive a prepared booklet, brochure or other publication (not shown) that includes previously submitted and selected tips from other account holders. The form of the publication of tips may also include granting the consumer access to an internet web site, accessible only by members.

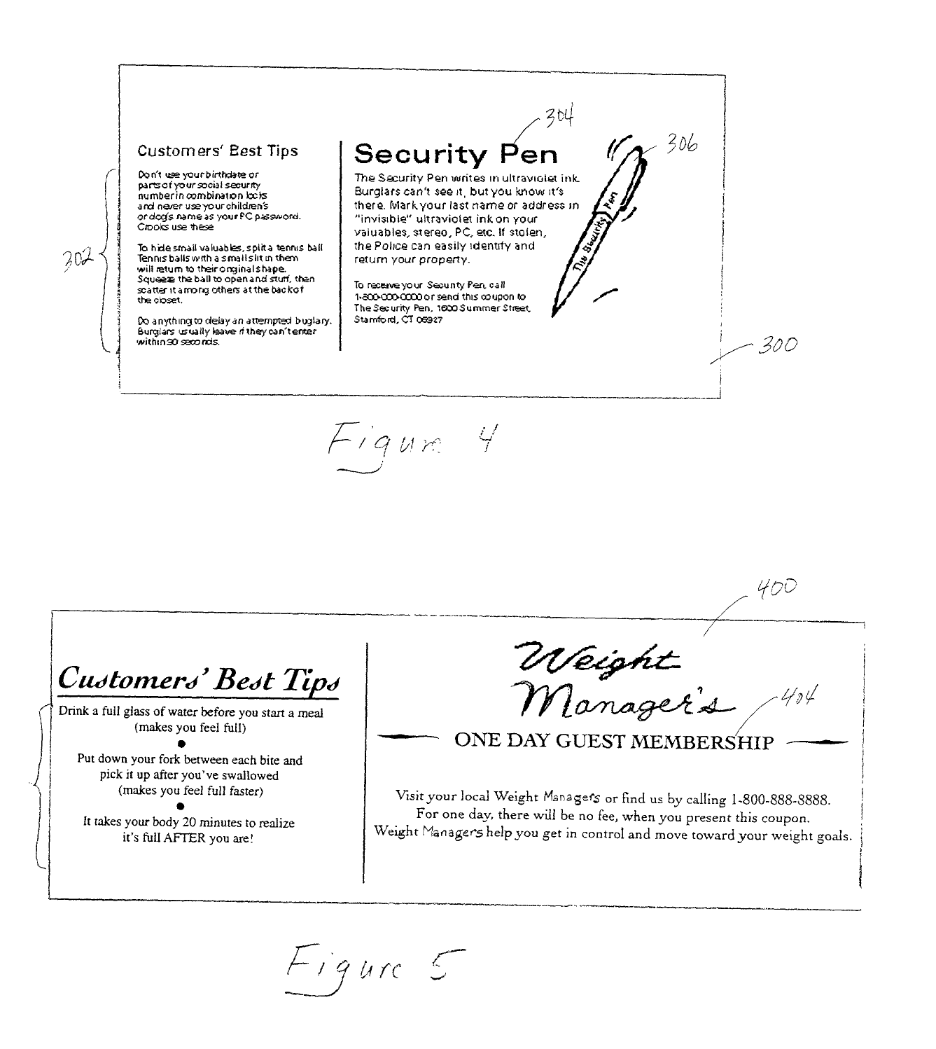

In addition to publishing selected tips, method 100 also features promotional offers, which may be targeted to certain consumers who have previously submitted consumer tips. Promotional offers may also be targeted to certain consumers demonstrating a particular purchasing pattern or patterns. FIG. 4 illustrates an example of one such promotional offer. A coupon 300 includes a list of three tips 302, which generally proffer advice on security matters. To the right of the tips 302 is an offer 304 for a “security pen” 306 that can mark objects with invisible, ultraviolet ink. In the example illustrated, the pen may be obtained by remitting the coupon 300 to the company manufacturing the pen.

In one embodiment of method 100, the coupon 300 may be attached to a sales receipt (not shown) or the like from a participating sales merchant when a purchase has been made with the credit card. Also, the coupon 300 could also be included with or on a credit card statement. However, method 100 also contemplates a targeted mailing to those consumers who have provided tips on security matters in the past. It may be reasonable, for example, to target an offer for a security pen to those individuals who have provided security tips in the past, based upon the assumption that those individuals may be more likely to be interested in that type of product.

Another exemplary promotion contemplated by method 100 is illustrated in FIG. 5. Coupon 400 includes a series of tips 402 relating to weight loss and control. To the right of tips 402 is a one-day, guest membership 404 for a weight management club. As is the case with the promotional offer shown in FIG. 3, the offer in FIG. 4 may be made available to all consumers belonging to the credit card account following a purchase. Or, the guest membership offer 404 may be targeted to those consumers that have previously provided tips on weight loss or fitness.

Finally, in addition to promotional offers distributed through printed coupons and tips, promotional offers may also be generated via electronic means. The electronic means may include e-mailing promotional materials to consumers or directing consumers to an internet web site which details a promotional offer.

By providing solicited consumer advice and related promotional offers to target groups of consumers, an additional benefit is provided in conjunction with a credit card account. Unlike other known promotional offers, the consumer advice (tips) comes directly from other consumers. Accordingly, consumers belonging to a group or having an account which employs the above described method also have access to “insider information”, thereby creating value and increasing desirability to belong to the group.

While the invention has been described with reference to a preferred embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A method for collecting and distributing consumer advice to a group of consumers, comprising:
soliciting consumer advice from the group of consumers;
collecting solicited advice submitted by the group of consumers;
evaluating individual submissions of said solicited advice; and
publishing selected individual submissions to said group of consumers.

2. The method of claim 1, wherein said selected individual submissions are published to a subset of said group of consumers.

3. The method of claim 1, further comprising evaluating the promotional value of said solicited advice to determine whether said advice shall be published in combination with a promotional offer.

4. The method of claim 1, wherein said consumer advice is solicited through a form to be filled out by the group of consumers.

5. The method of claim 3, further comprising generating a promotional offer, said promotional offer having a subject matter related to said advice.

6. The method of claim 5, wherein said promotional offer is targeted toward those consumers that have, prior to the time said promotional offer is generated, provided advice related to said subject matter of said promotional offer.

7. A method of providing a consumer financial service to a group of consumers, comprising:
issuing a credit account to the group of consumers;
soliciting consumer advice from the group of consumers;
collecting solicited advice submitted by the group of consumers;
evaluating individual submissions of said solicited advice; and
publishing selected individual submissions to said group of consumers.

8. The method of claim 7, wherein said selected individual submissions are published to a subset of said group of consumers.

9. The method of claim 7, further comprising evaluating the promotional value of said solicited advice to determine whether said advice shall be published in combination with a promotional offer.

10. The method of claim 7, wherein said consumer advice is solicited through a form to be filled out by the group of consumers.

11. The method of claim 9, further comprising generating a promotional offer, said promotional offer having a subject matter related to said advice.

12. The method of claim 11, wherein said promotional offer is targeted toward those consumers that have, prior to the time said promotional offer is generated, provided advice related to said subject matter of said promotional offer.
